(19) United States
(12) Patent Application Publication
(10) Pub. No.: US 2012/0097255 A1
(43) Pub. Date: Apr. 26, 2012

(54) APPARATUS, SYSTEMS AND METHODS FOR MONITORING CONSUMABLES IN SYSTEMS FOR THE MASS TRANSFER OF GASES INTO LIQUIDS

(76) Inventors: David Alan Reed, London (CA); Patrick Silva Fernandes, Kitchener (CA); Richard Beckett, Cambridge (CA); Scott Gregory Lammers, Waterloo (CA); Daniel James Hills, Waterloo (CA); Stephen Graham Munnings, Elmira (CA); Jessica Daisy Rodriguez, Kitchener (CA); Evan E. Koslow, Kitchener (CA)

(21) Appl. No.: 13/091,751

(22) Filed: Apr. 21, 2011

Related U.S. Application Data
(63) Continuation-in-part of application No. PCT/CA2009/000323, filed on Mar. 16, 2009.
Application No. PCT/CA2009/000323 is a continuation-in-part of application No. PCT/CA2009/000324, filed on Mar. 16, 2009.
(60) Provisional application No. 61/326,898, filed on Apr. 22, 2010.

(51) Int. Cl. F17D 3/00; B01F 3/04

(52) U.S. Cl. 137/2; 261/75

(57) ABSTRACT

A method for monitoring consumption of at least one consumable in a mass transfer system. The method includes providing at least one accurate mass transfer apparatus configured to provide mass transfer of a gas into a liquid to generate a liquid output, wherein the relative amounts of liquid and gas are set, and for each mass transfer apparatus: measuring the amount of liquid output, and determining, based on the amount of liquid output and the relative amounts of liquid and gas, a quantity of at least one of the gas and liquid consumed in that mass transfer apparatus.

### RELATED APPLICATIONS

This application is a continuation-in-part of International Application No. PCT/CA2009/000323 filed on Mar. 16, 2009, and entitled “Apparatus, Systems and Methods for Mass Transfer Of Gases Into Liquids”, the entire contents of which are hereby incorporated herein by reference for all purposes, and this application is also a continuation-in-part of International Application No. PCT/CA2009/000324 filed on Mar. 16, 2009, and entitled “Apparatus, Systems and Methods for Producing Particles”, the entire contents of which are hereby incorporated herein by reference for all purposes, and this application claims the benefit of U.S. Provisional Patent Application Ser. No. 61/326,898 filed Apr. 22, 2010 and entitled “Apparatus, Systems and Methods for Monitoring Consumables In Systems for the Mass Transfer of Gases Into Liquids”, the entire contents of which are hereby incorporated by reference herein for all purposes.

### TECHNICAL FIELD

The embodiments disclosed herein relate to mass transfer, and in particular to apparatus, systems and methods for monitoring mass transfer of gases into liquids, and more particularly to apparatus, systems and methods for monitoring consumables (for example gas and liquid) in systems for the mass transfer of gases into liquids, such as carbonators.

### Introduction

There are numerous industrial processes and types of equipment used to promote the mass transfer of gases into liquids. In many cases, the mass transfer of a gas into a liquid is limited by the mass-transfer resistance at the gas-liquid interface and the diffusion of the gas away from this interface. For example, the binary diffusion coefficient of carbon dioxide in air is 0.139 sq.cm/sec, while the binary diffusion coefficient for carbon dioxide in water is 0.00002 sq.cm/sec.

Since the diffusivity of a gas within a gas is typically around 1,000-10,000 times greater than the diffusivity of a gas into a liquid, dispersion of the liquid is important for effecting mass transfer of a gas into a liquid. For example, if a liquid can be dispersed as droplets having a characteristic droplet length roughly equal to the square root of the binary diffusion coefficient (e.g. for carbon dioxide into water, √0.00002=0.0044 cm, or 44 micrometers), then the diffusion will tend to be extraordinarily rapid.

Generally, to provide for optimum mass transfer rates, all of the liquid should be provided with a similar droplet size having the characteristic diffusion length. Any quantity of liquid that has a larger droplet size will not provide for rapid diffusion, and will not reach equilibrium in the surrounding gas environment within a brief period of time (as is the case with the smaller droplets).

In many prior art systems, the mass-transfer resistance may be partially overcome by increasing the gas-liquid surface (e.g. by performing mechanical work on the liquid). For example, some systems use powerful mechanical mixers to agitate the liquid. Other systems create small bubbles of gas by pressing a gas through small orifices, and then the bubbles are allowed to rise through a liquid column. However, neither of these approaches is particularly good at overcoming the mass-transfer resistance.

One technique that would be beneficial is to cause the liquid to be dispersed into the gas, rather than the gas into the liquid. In practice, however, this is very difficult to achieve. Some prior art systems attempt this using high-pressure nozzles to disperse a liquid as fine droplets. Other systems use a two-phase flow of gas and liquid through a nozzle at lower pressure. However, these types of systems are also generally undesirable, as they may require high-pressure, pressure-boosting pumps to be used, or make an undesirable use of gas to disperse the liquid (e.g. using two-phase nozzles). In particular, when attempting a precision transfer of gas into liquid, two-phase nozzles are often unacceptable as the amount of gas required to accomplish the required breakup of the liquid is normally not the quantity of gas that is desired to be transferred into the liquid.

Accordingly, such systems are not appropriate for many applications, especially where precise control of the ratio of gas to liquid is desired, such as in beverage carbonation (e.g. for soda pop and similar beverages).

One known carbonated beverage system is described in U.S. Pat. No. 3,877,358 to Karr. Karr describes a system for continuously preparing a carbonated product and filling containers. Carbon dioxide is applied to a liquid under carbonating pressure and the carbonated liquid is passed to a stabilizing tank maintained at a pressure at least equal to carbonating pressure. Thereafter, the liquid is directed to a pressure reduction tank in which the pressure is lowered to a level just sufficient to produce the desired flow rate to the filler. By reducing the pressure prior to filling, a filler of the gravity or vacuum type may be employed without excessive foaming. Or, if a counter pressure filler is employed, operating pressure is considerably lowered.

Another system is described in U.S. Pat. No. 5,156,871 to Goulet et al. Goulet et al. describe an apparatus for providing carbonating of water, that includes a carbonating tank having a carbon dioxide inlet, a water inlet, and a carbonated water outlet. The carbonating tank is pivotally mounted to a rigid structure and connected to an electric motor for providing an undulating or rocking motion of the carbonator about its pivot mounting. The motion of the carbonating tank provides for carbonating of the water held therein.

Another carbonator is described in U.S. Pat. No. 5,792,391 to Vogel et al. Vogel et al. describes a carbonator comprising a tube cylinder having a closed and an open end. A disk is removably retained in the open end for providing access into the interior volume thereof. The disk provides for mounting thereto of water and carbon dioxide gas inlets, a carbonated water outlet, a safety relief valve and a water level sensor. A rigid retaining wire is bent into a square configuration wherein radiussed corners thereof cooperate with slots in the open end of the cylinder to retain the disk therein. Manipulation of the retaining wire provides for removal of the disk from the cylinder when the carbonator is not pressurized.

Another carbonation system is described in European patent application no. EP 0 873 966 to Hassell. Hassell describes an in-line carbonation system for carbonating water or a non-carbonated pre-mix mixture. A flow restrictor meters a predetermined quantity of pressurized carbon dioxide gas to a T-fitting for carbonation with a known quantity of the liquid as delivered thereto by a pump. The carbon dioxide and liquid flow therefrom through a turbulator for enhancing of the absorption of the gas by the liquid, The liquid and gas then flow through a heat exchange cooling coil for further absorption of the gas as the liquid is cooled in the coil. The coil is connected to a dispensing valve for dispensing of the cooled carbonated liquid.

European patent application no. EP 0 677 740 to Butts describes a carbon dioxide measurement and control system which comprises a thermal conductivity carbon dioxide sensor and a humidity sensor which produce separate and independent output signals which are compared in a microprocessor, thereby generating a humidity compensated carbon dioxide gas measurement which is accurate to within plus or mins 0.1 percent.

Finally, PCT patent application no. WO/2002/059534 to Chadwell et al. describes a network topology for communications within and between food service equipment items generally having one or more food service equipment items, each having a controller and at least one functional subsystem configured as a slave to the controller, and a master interface and a bus slave interface associated with each controller. Each master interfaces is adapted for electrical communication over an intra-equipment communication channel with a slave interface associated with the functional subsystem. Each bus slave interface is adapted for communication, external to the food service equipment item, over an inter-equipment communication channel. Each bus slave interface is substantially electrically identical to each slave interface.

Another technique for dispersing liquid uses violent impaction of the liquid against a set of rotating blades. However, impaction is also undesirable, as the impacted liquid tends to be dispersed as droplets of poly-disperse sizes (e.g. some droplets are quite small while other droplets may be quite a bit larger). As discussed above, the larger droplets will tend not to reach equilibrium along with the smaller droplets, and thus do not provide for good diffusion of the liquid.

Furthermore, if the time provided for dispersion is extremely brief, then only a portion of the poly-disperse droplets may achieve a target gas content, and this proportion will be a complex function of the integrated gas transferred into the droplets of various sizes.

In the specific case of beverage carbonation (e.g. for soda pop and similar beverages), there are numerous examples of systems involving the mixing of bulk carbon dioxide and water, for example McCann et al. in U.S. Pat. No. 5,855,296; Hancock and May in U.S. Pat. No. 4,850,269; Burrows in U.S. Pat. Nos. 5,073,312 and 5,071,595; Vogal and Goulet in U.S. Pat. No. 5,792,391; Goulet in U.S. Pat. No. 5,419,461; Notar et al. in U.S. Pat. No. 5,422,045; Bellas and Derby in U.S. Pat. Nos. 6,935,624 and 6,758,462; Hoover in U.S. Pat. No. 4,745,853; and Singleterry and Larson in U.S. Pat. No. 5,842,600.

Some example systems include the use of a spinning turbine within a carbonator. For example, U.S. Pat. No. 5,085,810 (Burrows) describes using jets of liquid to drive an impeller that is affixed to an elongated shaft supporting a series of discs that are submerged in a liquid. In this case, the impeller is not driven by a motor, but instead is driven by the force of the incoming liquid, which is used to rotate the shaft (and thus cause the discs attached to the shaft to also rotate). Burrows does not focus on liquid dispersion through impaction, but is instead an effort to eliminate the drive motor normally used to rotate the submerged discs.

A nearly identical arrangement is described by Koenig and Erlanger in U.S. Pat. No. 610,062, published in 1898. Again, the incoming liquid is allowed to impinge upon an impeller so as to cause an elongated shaft to rotate, which rotates additional impellers submerged within a body of liquid, causing mixing.

U.S. Pat. No. 4,804,112 by E. L. Jeans describes a liquid entering a pressurized vessel containing carbon dioxide gas being allowed to impact a bladed rotor. The mechanism of causing the break-up of the liquid into droplets is impaction upon the blades of the rotor. As will be understood by those skilled in the art, impaction involves the turbulent breakup of the liquid, and results in the production of droplets varying widely in size (e.g. droplets with poly-disperse sizes). In addition, the size of the droplets generated by Jeans is generally large (e.g. larger than 75 micrometers) unless extraordinary impaction velocities are achieved (i.e. velocities approaching the speed of sound in a liquid).

Any large droplets formed through the use of impaction inhibits achieving gas absorption equilibrium, and hence a significant volume of the liquid in such systems will have insufficient gas saturation. Accordingly, elevated pressure must be used to achieve the target gas content within the liquid under such conditions. However, this creates a potential for exceeding the target saturation, especially if the liquid and gas are left within the carbonation chamber for an extended period of time.

Accordingly, there is a need in the art for improved apparatus, systems and methods for mass transfer of gases into liquids.

### SUMMARY

In some embodiments described herein, a fine dispersion of liquid is generated using a spinning disc apparatus or a rotating capillary apparatus to generate small liquid particles. The small liquid particles are then dispersed into gas to carry out the mass transfer of the gas into the liquid droplets. The liquid particles may then coalesce with the chamber and/or against the walls of the chamber, and be subsequently collected for extraction.

Generally, it is desirable that the liquid dispersion produces an exact droplet size, or at least a dispersion of liquid droplets that are almost entirely and reliably below a critical size, so as to closely approach equilibrium with the surrounding gas within extremely brief time scales. In some examples, it would be desirable to perform such dispersion in less than a few seconds, and in some cases within tens of milliseconds.

The embodiments described herein generally form droplets of uniform or near-uniform size through the use of elegant physics for droplet formation and by balancing forces at the edge of a generally flat spinning disc or within a rotating capillary. In addition, the power consumption for such embodiments tends to be very low. Furthermore, the edge velocities and angular velocities required to achieve essentially complete reduction of the liquid into the required droplet size tend to be quite modest.

Some embodiments as described herein provide a simple apparatus that tends to produce a uniform and precise dispersion of a liquid into a mist or spray having a specific droplet size and with minimal potential for any significant volume of the liquid being dispersed as over-sized droplets (e.g. droplets that are larger than desired).

In some examples, this dispersion may be carried out within a space or chamber that operates at elevated pressure so as to cause a gas to rapidly dissolve into the liquid droplets and approach equilibrium saturation during the flight time of the droplets (e.g. between when they are thrown or disengage from the spinning disc and before contacting the walls of the chamber).

To accomplish the required mass transfer within the brief flight time of the droplets, the droplets generally should be extremely small. Furthermore, the distance between the edge of the spinning disc and the walls of the chamber should be sufficient to allow the droplets to closely approach saturation with the surrounding gas prior to being arrested against the walls. If the droplets are sufficiently small, they will slow and even come to rest before engaging the chamber walls and thus their contact time with the gas can be extended.

According to one aspect, there is provided an apparatus for mass transfer of gas into a liquid, comprising a tank that defines a chamber for receiving the gas, and at least one surface provided within the chamber, each surface having an inner region, an outer region and an edge adjacent the outer region, wherein each surface is configured to receive the liquid at the inner region and rotate such that the liquid flows on the surface from the inner region to the outer region, and, upon reaching the edge of the surface, separates to form liquid particles that move outwardly through the gas in the chamber, and wherein the liquid particles are sized so that the gas is absorbed by the liquid particles to produce a mixed liquid saturated with the gas during a brief flight time of the liquid particles through the chamber.

According to another aspect, there is provided a carbonator for mass transfer of carbon dioxide into water, comprising a tank that defines a chamber for receiving the carbon dioxide, and at least one surface provided within the chamber, each surface having an inner region, an outer region and an edge adjacent the outer region, wherein each surface is configured to receive the water at the inner region and rotate such that the water flows on the surface from the inner region to the outer region, and, upon reaching the edge of the surface, separates to form water particles that move outwardly through the carbon dioxide in the chamber, and wherein the water particles are sized so that the carbon dioxide is absorbed by the water particles to produce a carbonated water saturated with the carbon dioxide during a brief flight time of the water particles through the chamber.

According to yet another aspect, there is provided a method for mass transfer of gas into a liquid, comprising the steps of providing a chamber having the gas therein, providing at least one surface within the chamber, each surface having an inner region, an outer region and an edge adjacent the outer region, providing a liquid to the inner region of each surface, and rotating the surface at an angular velocity selected such that the liquid will move from the inner region to the outer region, and, upon reaching the edge, separates from the at least one surface to form at least one liquid particle that moves outwardly through the gas, wherein the liquid particles are sized so that the gas is absorbed by the liquid particles to produce a mixed liquid saturated with the gas during a brief flight time of the liquid particles through the chamber.

According to yet another aspect, there is provided a method for monitoring consumption of at least one consumable in a mass transfer system, comprising: providing at least one accurate mass transfer apparatus configured to provide mass transfer of a gas into a liquid to generate a liquid output, wherein the relative amounts of liquid and gas are set; and for each mass transfer apparatus: measuring the amount of liquid output; and determining, based on the amount of liquid output and the relative amounts of liquid and gas, a quantity of at least one of the gas and liquid consumed in that mass transfer apparatus.

The method may further comprise, for one or more of the mass transfer apparatus, communicating the quantity of gas consumed by that mass transfer apparatus to a data center, and performing at least one data analysis on the quantity of gas consumed.

The method may further comprise adjusting a delivery schedule for the gas to one or more of the mass transfer apparatus based on the quantity of gas consumed at the one or more mass transfer apparatus.

The method may further comprise, for one or more of the mass transfer apparatus, communicating the quantity of liquid consumed by that mass transfer apparatus to a data center, and performing at least one data analysis on the quantity of liquid consumed.

In some embodiments, the relative amounts of liquid and gas may be set according to an equilibrium condition in the mass transfer apparatus.

In some embodiments, the gas is carbon dioxide and the mass transfer apparatus is a carbonator.

In some embodiments, each mass transfer apparatus comprises: a tank that defines a chamber for receiving the gas; and at least one surface provided within the chamber, each surface having an inner region, an outer region and an edge adjacent the outer region; wherein each surface is configured to receive the liquid at the inner region and rotate such that the liquid flows on the surface from the inner region to the outer region, and, upon reaching the edge of the surface, separates to form liquid particles that move outwardly through the gas in the chamber; and wherein the liquid particles are sized so that the gas is absorbed by the liquid particles to produce a liquid saturated with the gas during a flight time of the liquid particles within the chamber.

In various embodiments, the liquid may be water, beer, fruit juice, flavoured juice, coffee, a coffee flavored beverage, tea, a pre-mix or another suitable liquid.

According to yet another aspect, there is provided a system for monitoring consumption of at least one consumable in a mass transfer system, comprising: at least one consuming station, each station having: an accurate mass transfer apparatus configured to provide mass transfer of the gas into the liquid to generate a liquid output, wherein the relative amounts of liquid and gas are set; and a sensor configured to monitor the quantity of liquid output; at least one processor configured to determine, based on the quantity of liquid output and the relative amounts of liquid and gas, a quantity of at least one of the liquid and the gas consumed in the mass transfer apparatus.

The system may further comprise a data center configured to communicate with the at least one processor to monitor the quantity of at least one of the gas and liquid consumed by each station. The data center may be configured for performing at least one data analysis on at least one of the quantity of gas and liquid consumed. The data center may be configured to adjust a delivery schedule for at least one of the gas and liquid based on the quantity of at least one of the gas and liquid consumed by each station.

### BRIEF DESCRIPTION OF THE DRAWINGS

The drawings included herewith are for illustrating various examples of apparatus, systems and methods of the present specification and are not intended to limit the scope of what is taught in any way. In the drawings:

FIG. 1 is a cross-sectional perspective view of an apparatus for mass transfer of a gas into a liquid according to one embodiment;

FIG. 2 is a cross-sectional elevation view of the apparatus of FIG. 1;

FIG. 3 is an overhead schematic view of the spinning disc and chamber of the apparatus of FIG. 1;

FIG. 4 is a cross sectional elevation view of a rotor assembly for an apparatus for mass transfer of a gas into a liquid according to another embodiment;

FIG. 5 is a view of a general-purpose chemical process industry amplifier according to one embodiment;

FIG. 6 is a close-up partial view of the apparatus of FIG. 5 showing the edges of the rotor plates in detail;

FIG. 7 is an overhead schematic view of the disc and chamber showing an optional ring member;

FIG. 8 is a side view of the ring member of FIG. 7 according to one embodiment;

FIG. 9 is a side view of the ring member of FIG. 7 according to another embodiment;

FIG. 10 is a system for monitoring consumables in systems for the mass transfer of gases into liquids.

### DETAILED DESCRIPTION

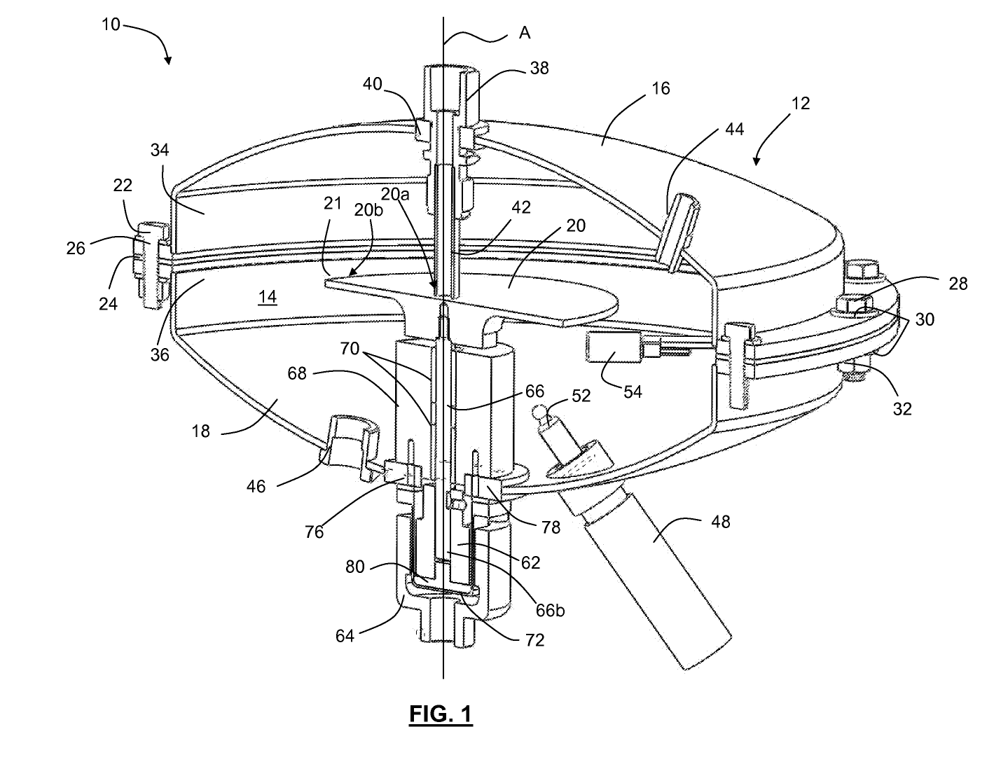

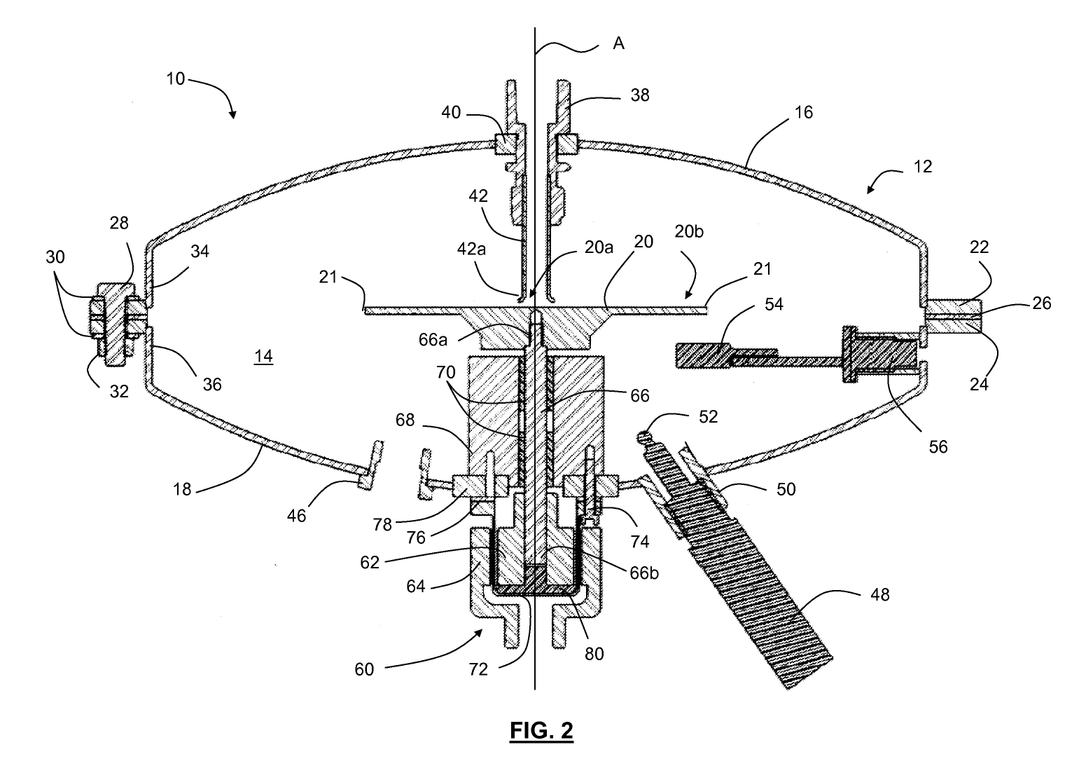

Illustrated in FIGS. 1 to 3 is an apparatus 10 for mass transfer of a gas into a liquid according to one embodiment of the invention.

The apparatus 10 generally includes a tank 12 that defines a chamber 14 into which the gas and liquid may be generally received for effecting the mass transfer.

The apparatus 10 also generally includes a disc 20 that is provided within the chamber 14. The disc 20 has a surface configured to receive a liquid thereon and can rotate so as to cause a fine dispersion of liquid particles to be ejected from the edges thereof, as will be described in greater detail below.

The tank 12 may be a pressure vessel or any other suitable vessel, and may be capable of operating at elevated pressures according to the desired operating conditions of the apparatus 10. For instance, in some examples, the tank 12 may be configured to operate up to pressures of 3 atmospheres or greater.

As shown, the tank 12 may include a separate top tank head 16 and bottom tank head 18, each having upper and lower mounting flanges 22, 24 extending outwardly from the perimeter thereof. The mounting flanges 22, 24 may be coupled together using one or more fasteners (e.g. bolts 28, washers 30 and nuts 32) so as to secure the upper tank head 16 and lower tank head 18 together to define the chamber 14 therebetween.

In some examples, a flange gasket 26 may be provided between the flanges 22, 24 so as to help seal the tank heads 16, 18 together and to inhibit leaks.

As shown, each of the upper and lower tank heads 16, 18 have outer walls generally located around the perimeter of the chamber 14. For example, the upper tank head 16 has a peripheral upper chamber wall 34, and the lower tank head 18 has a peripheral lower chamber wall 36.

As shown, the upper tank head 16 has a bulkhead fitting 38 (or liquid inlet fitting). The bulkhead fitting 38 is configured to be coupled to a liquid supply (e.g. using a hose, not shown) so that liquid may be pumped into the chamber 14 during use of the apparatus 10.

The upper tank head 16 may include an upper puck 40 for securing the bulkhead fitting 38 to the tank head 16. The upper puck 40 may help to stabilize the upper tank head 16 so as to provide for a more secure coupling of the bulkhead fitting 38. In some examples, the bulkhead fitting 38 and upper puck 40 may be welded to the upper tank head 16.

The bulkhead fitting 38 is coupled to an inlet spout 42 that extends generally downwardly into the chamber 14. The inlet spout 42 is configured to provide liquid to an inner region 20a of the spinning disc 20 during use of the apparatus 10, as will be described in greater detail below.

The upper tank head 16 also generally includes a gas inlet 44 (shown in FIG. 1). The gas inlet 44 is configured to be coupled to a gas supply using a coupling member (e.g. a hose, not shown) for providing gas to the chamber 14 during use of the apparatus 10.

The lower tank head 18 also generally includes an outlet fitting 46. The outlet fitting 46 is configured to allow extraction of the gas and liquid mixture (e.g. using a hose, not shown) that is generated by the apparatus 10 and which tends to collect in the lower tank head 18 during use.

The apparatus 10 may also include a pH sensor 48, which may be coupled to the lower tank head 18 using a sensor fitting 50. The pH sensor 48 has a sensor tip 52 that extends into the chamber 14 and is configured to measure the pH levels of the gas-liquid mixture that collects in the lower tank head 18.

Based on the pH levels observed by the pH sensor 48, the properties of the gas-liquid mixture can be monitored and decisions may be made about the operation of the apparatus 10, such as whether additional quantities of liquid and/or gas should be added to the apparatus 10, and/or whether the gas-liquid mixture is ready for extraction via the outlet fitting 46.

In some examples, the tank 12 also includes a float switch 54 mounted to the lower tank head 18 via a switch fitting 56. The float switch 54 may be configured to monitor the level of the gas-liquid mixture within the lower tank head 18. Based on the height of the mixture, the float switch 54 may be used to trigger extraction 46 of the mixture, control the rate of liquid flowing in through the inlet spout 42, and/or take other actions.

In particular, the float switch 54 can ensure that the level of mixed liquid in the chamber 14 remains below the surface of the disc 20, so that liquid from the inlet spout 42 does not immediately contact the mixture, but is first dispersed by the disc 20 (as will be described in greater detail below). This also tends to ensure that the mixture does not interfere with the rotation of the disc 20.

The apparatus also generally includes a drive mechanism 60 configured for rotating or spinning the disc 20 about an axis of rotation A. The drive mechanism 60 may generally be any suitable drive (e.g. a magnetic drive) and may include an inner rotor 62 configured to rotate and an outer rotor 64 that is mechanically coupled to an electric motor or other suitable source of powered rotation. For instance, in this example, the inner and outer rotors 62, 64 are magnetically coupled so that the inner rotor 62 rotates when the outer rotor 64 is caused to rotate.

The inner rotor 62 is generally coupled to a shaft 66 that extends upwardly into the chamber 14. The shaft 66 has an upper portion 66a that is coupled to the disc 20 so that as the inner rotor 62 rotates, the shaft 66 and disc 20 also rotate.

The shaft 66 may be received within a shaft housing 68 configured to support and stabilize the shaft 66 and disc 20 during rotation. One or more journal bearings 70 may be provided between the shaft 66 and housing 68 so as to inhibit wear during rotation. In some examples, the journal bearings 70 may be plastic, or any other suitable material.

In some examples, a cap 72 may extend downwardly from the bottom of the lower tank head 18. The cap 72 may house elements of the drive mechanism 60 (e.g. the inner rotor 62 and a lower portion of 66b of the shaft 66) generally below the tank 12, which may facilitate the operation of the drive mechanism 60 (e.g. the magnetic coupling between the inner and outer rotors 62, 64).

As shown, the cap 72 may be coupled to a lower puck 78 provided in the lower tank head 18 using one or more fasteners 74, and may have a gasket 76 provided between the lower puck 78 and the barrier 72 to assist with inhibiting leaks.

In some examples, the inner rotor 62 may be coupled to a thrust bearing 80 (which may be plastic or any other suitable material).

The drive mechanism 60 may be used to rotate the disc 20 at elevated speeds selected according to the desired operating conditions of the apparatus 10. For example, the disc 20 may be rotated at speeds up to and including 3600 RPM. Alternatively, the disc 20 may be rotated at speeds of greater than 3600 RPM.

In some examples, the tank 12 may also include a safety release valve (not shown) so as to inhibit an overpressure situation from forming within the chamber 14, and which could otherwise damage the components therein and/or cause the tank 12 to crack or burst.

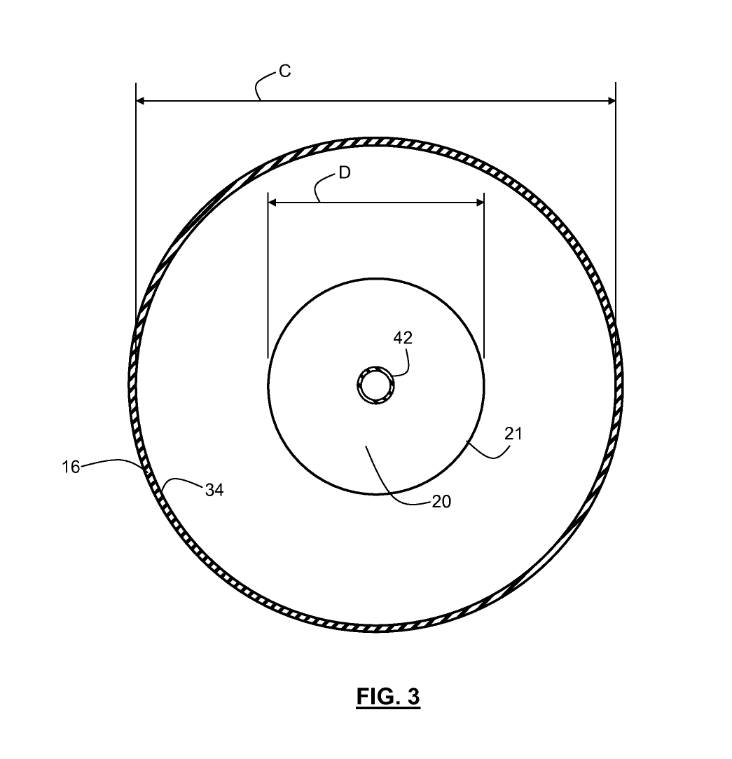

As shown, the disc 20 generally has a flat upper surface (as shown in FIG. 1) and has a circular shape, with a disc diameter D (as shown in FIG. 3). However, in other examples, the disc 20 may have other shapes (e.g. the surface of the disc 20 may be convex or concave, the disc 20 may not be circular, etc.).

In some examples, the disc 20 may be made of a metal (e.g. steel, aluminum, etc.). In other examples, this disc 20 may be made of another material that is suitable for rotation at elevated speeds, such as high-strength plastics or ceramics.

During use of the apparatus 10, liquid (e.g. water) may be fed to the inner region 20a of the disc 20 using the inlet spout 42, and the drive mechanism 60 may be used to rotate the disc 20 about the axis of rotation A.

As shown, a lower end portion 42a of the inlet spout 42 may be positioned adjacent or directly above the upper surface of the disc 20. Accordingly, the liquid can be directed onto the disc 20 in a generally smooth manner (e.g. without violent impaction that could cause poly-disperse sizes of droplets to be formed).

The rotation of the disc 20 generally causes the liquid to move from the inner region 20a outwardly towards an outer region 20b of the disc 20. As the liquid moves outwardly, it tends to spread upon the surface of the disc 20, generally forming a thin film.

Once the liquid reaches the outer edge 21 of the disc 20, it may collect at the edge, and then eventually separate from the edge 21 as particles or droplets.

Once separated, the particles of liquid will fly outwardly through the surrounding atmosphere in the chamber 14 towards the chamber walls 34, 36. During this flight, the particles will interact with gas fed into the chamber 14 using the gas inlet 44 (e.g. carbon dioxide). In some example, the gas may be continuously fed into the chamber 14. In other examples, the gas may be intermittently fed into the chamber 14.

Generally, the liquid particles are sufficiently small that the gas will rapidly dissolve into them and approach equilibrium saturation during the flight time of the particles (e.g. between disengaging from the spinning disc 20 and contacting the walls 34, 36 of the chamber 14). In some examples, the flight time is less than 100 milliseconds. In yet other examples, the flight time is less than 50 milliseconds.

To accomplish the required mass transfer within the brief flight times of the droplets, the droplets should be extremely small and be of exact or very similar droplet sizes, or at least be almost entirely and reliably below a critical droplet size, so as to closely approach equilibrium with the surrounding gas. For example, in some examples, the droplets should be less than 100 microns in diameter. In other examples, the droplets should be less than 60 microns in diameter.

Furthermore, the distance between the edge 21 of the spinning disc 20 and the walls 34, 26 of the chamber 14 should be selected to allow the droplets to closely approach saturation with the surrounding gas prior to being arrested against the walls 34, 36. Accordingly, the chamber 14 should have a chamber diameter C sufficiently larger than disc diameter D such that the droplets have an extended life within the atmosphere prior to their coalescence into larger droplets or against a surface of the chamber walls 34, 36.

Generally, the chamber diameter C will be selected such that the droplets will tend to come to rest within the atmosphere before contacting the chamber walls 34, 36. Thus, the particles will have an extended life within the gas prior to coalescence so as to obtain a desired equilibrium level.

However, in some cases, the chamber diameter C may be sufficiently small so that the droplets tend to reach the walls 34, 36 before being arrested by the atmosphere in the chamber 14, thus coalescing on the walls 34, 36.

Once arrested within the atmosphere (or on the walls 34, 36), the gas-liquid droplets will tend to collect and/or grow and will eventually fall into the lower tank head 18, where they can be subsequently extracted via the outlet fitting 63. In this manner, the apparatus 10 can be used to provide for mass transfer of gases into liquids.

Generally, the following equation can be used to estimate the diameter of water droplets produced by the spinning disc 20:

d=4/[Ω(Dρ/σ)^{1/2}] (1)

where d is the droplet diameter in centimeters, Ω is the rate of rotation of the disc 20 in revolutions per minute (RPM), D is the disc diameter in centimeters, ρ is the density of the liquid medium being dispersed as droplets, and σ is the surface tension of the liquid medium.

In some cases, where the liquid does not perfectly wet the spinning disc 20, this equation should be corrected by dividing the answer by cos(φ), where (φ) is the wetting contact angle. For example, water often does not have a wetting reaction with metal surfaces (e.g. a metal spinning disc 20). Accordingly, in some examples such surfaces may be chemically or physically modified (e.g. using a coating) to provide hydrophilic surfaces, where cos(φ) is roughly equal to unity.

It has been found that the roughly monodisperse droplets produced by the spinning disc 20 travel a given fixed distance in the surrounding gaseous medium (based on the operating conditions of the apparatus 10) before their velocity declines to essentially the ambient drag velocity within the gas. The result is a cloud of droplets accumulating in a dense and stationary ring at a generally fixed distance from the spinning disc 20. This fixed distance generally follows the form:

X/d=P (2)

where X is the distance the primary droplet travels from the spinning disc in centimeters before the droplet loses their kinetic energy and come roughly to rest, and P is a constant that may be determined by observation. For example, for water droplets released into air at ambient pressure, P is equal to 2540.

Substituting equation (1) into (2), and adding a term to account for the viscosity of a surrounding atmosphere in the chamber 14 (e.g. carbon dioxide) under pressure as compared with ambient air, the following equation may be obtained to solve for the distance X:

X=10,100/[Ω(Dρ/σ)^{1/2}]*(ηₐᵢᵣ/η_{co2}) (3)

The ratio of viscosities for air (171 micro Poise) and carbon dioxide (139 micro Poise) is approximately 1.23, and this is roughly independent of the surrounding gas pressure. The surface tension of water is approximately 72 dynes/cm, and the density of water is 1.00 grams/cm³, all at a temperature of approximately 4° C.

In some embodiments, the maximum flow rate, Qₘₐₓ of liquid that can be fed onto the spinning disc 20 is limited by the volume that would “flood” the surface and inhibit the formation of small droplets. This maximum flow rate is roughly equal to:

Qₘₐₓ=π²D²Ωd=(4π²D²)/(Dρ/σ)^{1/2} (4)

### Example 1

### Calculated Droplet Size and Distance of Droplet Projected from an Apparatus Operating as a Carbonator

According to one example, the apparatus 10 was configured with the spinning disc 20 having a disc diameter D of 10 cm, and using an AC synchronous motor to drive the drive mechanism 60.

When operating such an apparatus 10 with the disc 20 rotating at 3600 RPM, a carbon dioxide atmosphere with an absolute pressure of 45 psi (roughly 3 atmospheres) within the chamber 14, and water as the liquid, droplets of 0.00298 cm (roughly 30 micron) can be produced. Under these conditions, droplets of this size tend to be thrown a distance of approximately 9.2 cm from the edge 21 of the disc 20 prior to being arrested by their friction within the surrounding gas.

Accordingly, the chamber diameter C should be made larger than 28.4 cm to enhance the contact time between droplets or particles and the surrounding atmosphere in the chamber 14 and provide for improved dispersion of the carbon dioxide into the water. After coalescing, the gas-liquid mixture can be collected in the bottom tank head 18, and subsequently extracted.

Alternatively, the chamber diameter C may be selected to be less than 28.4 cm if it is desired that the liquid droplets impact the walls 34, 36 of the chamber 14 rather than become entrained within the surrounding atmosphere.

The roughly 30 micron droplets produced by the spinning disc 20 in this example will tend to achieve approximately 97% equilibrium with the surrounding carbon dioxide atmosphere in approximately 0.05 seconds after leaving the edge 21 of the disc 20. However, because of time spent by the liquid spreading upon the surface of the disc 20 (prior to separation from the edge 21), the actual equilibrium results are generally better than is predicted by the diffusion into droplets alone.

If the walls 34, 36 of the chamber 14 in this example are selected to be larger than the specified 28.4 cm, then the droplets produced by the spinning disc 20 will tend to accumulate within a dense cloud at this distance, and will have much greater residence time within the gas atmosphere of the chamber 14 prior to coalescing into larger droplets.

The maximum recommended flow rate (Qₘₐₓ, calculated using equation (4) above) for this particular example is approximately ten liters of liquid per minute. It can be seen by inspection of equation (4) that the maximum flow rate of the apparatus 10 can be improved by increasing the size of the disc 20, and not through an increase in the speed of rotation of the disc 20. The system can be operated above the Qₘₐₓ value, but generally only in cases where mass transfer is favored, such as in carbonation.

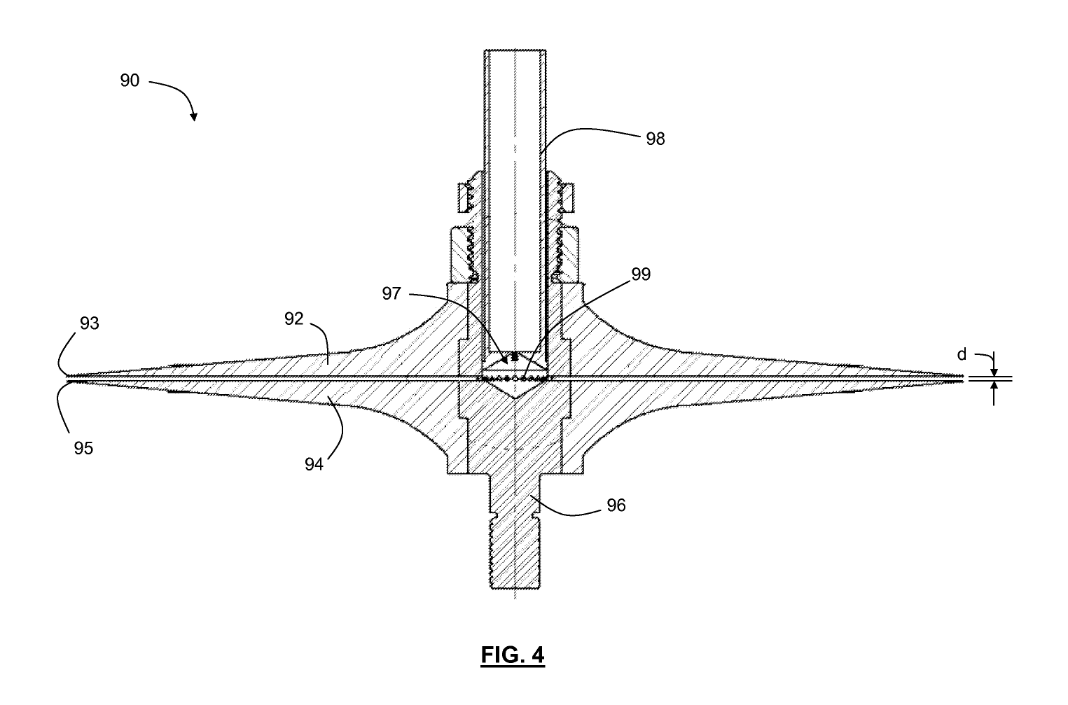

In some examples, a rotating capillary may be used in an apparatus instead of the spinning disc 20. For example, illustrated in FIG. 4 is a rotor assembly 90 for use with an apparatus according to another embodiment of the invention.

The rotor assembly 90 generally includes one or more surfaces sized and shaped so as to define at least one capillary, and is configured to be rotated at an angular velocity selected such that liquid received in an inner region will adopt an unsaturated condition on each surface (as the liquid moves outwardly) such that the liquid flows as a film along the at least one surface and does not continuously span the capillary. Upon reaching the edge of the capillary, the liquid separates to form particles or droplets.

As shown, the rotor assembly 90 typically includes a set of circular plates (e.g. an upper plate 92 and a lower plate 94) spinning together on a hub or spindle 96. The upper and lower plates 92, 94 are spaced apart by a gap distance “d” and generally define the capillary therebetween.

In this embodiment, the liquid is provided into an inner region 97 of the rotor assembly 90 using a feed tube 98. The liquid is then allowed to flow into the capillary (e.g. between the two plates 92, 94, in some cases via apertures 99 in the feed tube 98). As the rotor assembly 90 rotates, the liquid moves outwardly between the plates 92, 94, reaching the edges 93, 95 of the plates and eventually separating from the edges 93, 95 as particles (e.g. fine ligaments, droplets or fibers, depending upon the properties of the liquid and the operating conditions of the rotor assembly 90).

In some examples, the liquid may transition from saturated flow (e.g. flow that spans the gap width d) to unsaturated flow (e.g. flow that does not span the gap width but which exists as thin films) within the capillary and before separating from the edges 93, 95. In an unsaturated condition, the liquid does not span the entire gap width, but rather exists as separate thin films on the surfaces of each of the upper plate 92 and lower plate 94, as urged by the increasing centripetal force as the liquid moves toward the outer edges 93, 95 of the plates 92, 94.

The use of such a spinning rotor assembly 90 tends to allow roughly double the flow rates, since two surfaces are being used for the release of the droplets.

In some examples, the rotor assembly 90 may be provided and operated within a tank 12 in a manner similar to that of the disc 20 as described above.

In some examples, the two plates 92, 94 may be coated with a hydrophilic medium or other coating to facilitate a transition from saturated flow within the capillary to unsaturated flow.

In some examples, as shown in FIG. 4, the edges 93, 95 of the plates 92, 94 may be sharp edges having a radius selected so to inhibit the accumulation of liquid thereon.

In other examples, the edges 93, 95 may be blunt edges. In yet other examples, each of the edges 93, 95 may be bifurcated (e.g. the edges 93, 95 may be V-shaped or U-shaped) so as to provide an upper edge and lower edge on each of the edges 93, 95.

In some examples, three or more plates may be stacked together in an array in a rotor assembly. For example, the rotor assembly 90 may be modified by providing one or more intermediate rotor plates between the upper plate 92 and lower plate 94. These intermediate rotor plates will cooperate with the upper and lower plates 92, 94 so as to define capillaries between each pair of opposing surfaces. The intermediate plates may have sharp edges, blunt edges, bifurcated edges, or any combination thereof.

Further details on the rotor assemblies that may be used are described in the PCT Patent Application No. PCT/CA2009/000324 entitled “Apparatus, Systems and Methods for Producing Particles Using Rotating Capillaries”, filed on Mar. 16, 2009 in the Canadian Intellectual Property Office, the entire contents of which are hereby incorporated by reference.

According to some of the embodiments described herein, it is possible to achieve exceptionally high performance mass transfer of gases (e.g. carbon dioxide) into liquids (e.g. water).

Generally, the apparatus, systems and methods described can be used within very small or very large-scale applications, especially when such gas transfer is accomplished at elevated pressures and where the uniformity and proportion of gas transferred to each unit of liquid must be exceptionally precise.

For example, if the liquid reaches greater than 95% of equilibrium with the surrounding gas atmosphere in less than 50 msec, then the apparatus as described herein might be considered to be a “near perfect” mass transfer device, where liquid always emerges at the desired gas saturation regardless of the actual residence time.

The apparatus and methods can be used in applications where the mass-transfer process might support chemical or biological processes, or for use in producing carbonated liquids. Some examples include oxygen transfer to support fermentation, aerobic digestion, gas-liquid chemical engineering processes or three-phase processes (e.g. where a solid is dispersed in a liquid that contains a dispersed or dissolved gas).

One typical case is carbonation, where it is desirable to transfer a precise volume of carbon dioxide gas into a precise quantity of water. Excessive carbonation at elevated pressure tends to result in undesirable foaming or “flashing” of carbonated drinks dispensed through a nozzle (as in post-mix applications). Alternatively, inadequate carbonation results in a “flat tasting” drink.

Failure to obtain optimal carbonation is said to be the single most common and pervasive source of quality control problems in carbonated beverage production in post-mix systems, even more common than problems with syrup blending (e.g. Brix control).

By using the various embodiments described herein, it may be possible to accomplish a precise transfer of gas into a liquid without complexity or recourse to complex sensors, feedback loops, or controls. Instead, it is achieved through nearly instantaneous accomplishment of the desired equilibrium using physics and mass-transfer principles.

However, in some embodiments it may be desirable to provide for additional sensing or monitoring (or both) of consumables (e.g. gas or liquid) used in mass transfer systems, such as in carbonators.

In beverage systems, the quality of a carbonated beverage is considered to be very dependent upon the amount of carbon dioxide absorbed into the water or other liquid in the beverage.

Carbonation normally has three variables that affect the amounts of carbon dioxide, nitrogen or other gas that will be absorbed into the water or other liquid pre-mix: the pressure of the fluid, the temperature of the fluid, and the equilibrium amount of gas (e.g. carbon dioxide) that can be absorbed into the liquid.

Prior art carbonators are normally slow to reach the desired equilibrium state. Accordingly, this tends to result in over-carbonation of the liquid (e.g. excessive amounts of carbon dioxide are absorbed into the water or pre-mix liquid) or under-carbonation of the liquid (e.g. too little carbon dioxide is absorbed into the water or pre-mix liquid). Generally, pressures in these prior art carbonation systems are manually calibrated “on site” (e.g. where the carbonation occurs) in an attempt to provide the desired equilibrium depending on the temperature of the liquid supply (e.g. the water supply temperature). However, the liquid supply temperature is prone to change, which can lead to deviations from the desired equilibrium operating conditions.

However, new developments in carbonator technology, including those based on the teachings as described herein, provide for the ability to more quickly reach equilibrium states for gas absorption (in some cases virtually instantaneously). Accordingly, using the teachings as described herein, the desired equilibrium can be more consistently reached regardless of the various temperatures and pressures experienced in the system.

In particular, these apparatus and systems can encourage quickly reaching an equilibrium condition within the mass transfer apparatus, and can provide for the ability to provide for accurate and consistent control of process variables and thus allow for more accurate estimation of how much of a particular consumable is being used in the mass transfer process (e.g. gas, liquid, etc.).

More accurately monitoring gas consumption may provide a number of benefits to gas and/or liquid suppliers and consumers of gas and/or liquid products, including but not limited to improved supply chain management, better management of raw materials (e.g. gas or liquid supplies), and improved fleet and delivery management. For example, by more accurately monitoring gas consumption, fewer delivery trips may be needed to deliver the required gas supplies, or delivery trips could be scheduled at varying intervals according to the actual quantities of gas consumed.

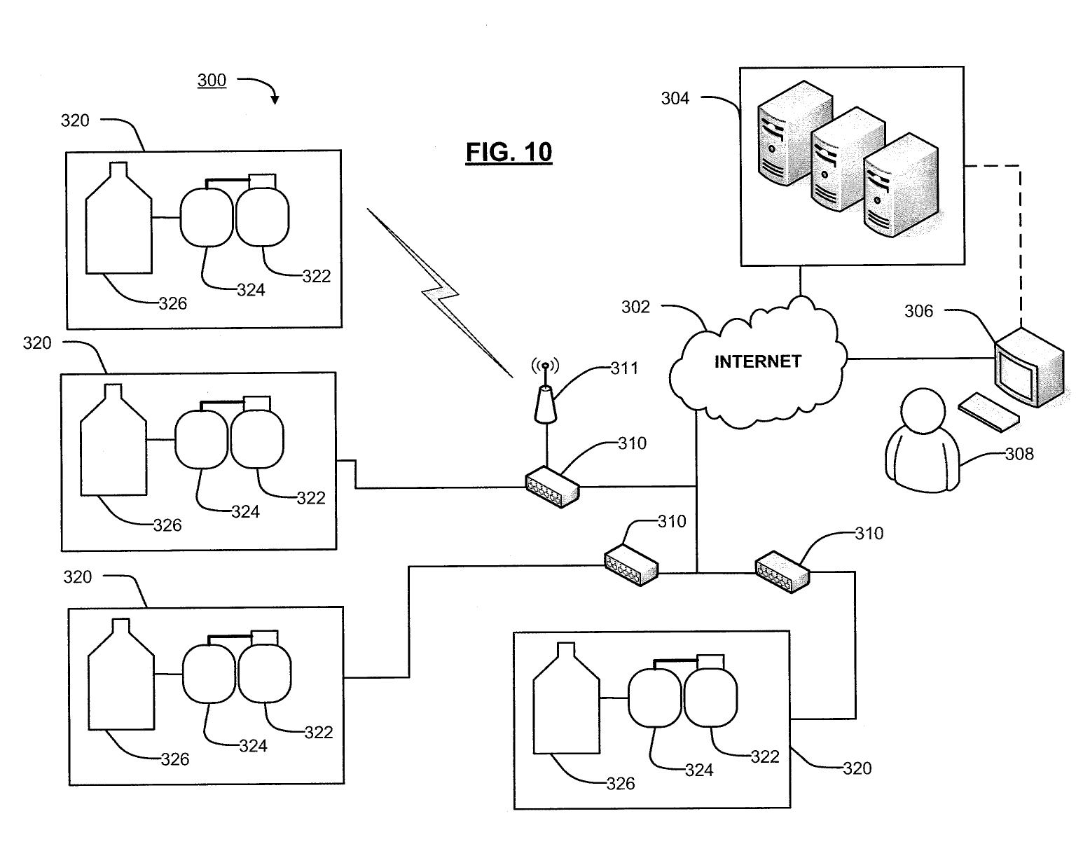

For example, one system 300 for providing monitoring the consumption of consumables (e.g. gas or liquid, or both) is shown in FIG. 10.

The system 300 generally includes one or more consuming stations 320, which may be provided in retail stores, restaurants, convenience stores, and so on.

Each station 320 may generally include a carbonator 322 (or other mass transfer apparatus), and which may be similar to or the same as the mass transfer apparatus 10 described herein and configured for use as a carbonator. According to the teachings as described herein, each carbonator 322 or mass transfer apparatus is configured to be consistent and accurate and thus allow for accurate measurement of the consumables used.

Each station 320 may also be coupled to one or more gas storage tanks 326, which are used to supply carbon dioxide (or other gases) to the carbonator 322.

In some embodiments, the station 320 may also include an output holding tank 324 for temporarily storing the carbonated liquid output by the carbonator 322.

In some embodiments, the gas storage tanks 326 may be removable such that they can be picked up and replaced by a gas supply company. In other embodiments, the gas storage tanks 326 may be recharged on site (e.g. by using a truck with a pressurized gas tank thereon).

Generally, determining the quantity of gas remaining within a gas storage tank 326 is difficult and/or inaccurate when using conventional measurement systems. Prior solutions have included weight measurement (e.g. measuring the weight of the tank) and optical inspection, however such techniques are prone to error and in some cases may require additional equipment (e.g. scales), which is generally undesirable.

However, using the carbonator 322 and other mass transfer devices according to the teachings as described herein generally provide for consistent and accurate output of carbonated liquid. In particular, the carbonator 322 can be configured to quickly reach an equilibrium condition (as described in a related US Provisional patent application entitled “Apparatus, Systems and Methods for Controlling the Mass Transfer Of Gases Into Liquids”, filed on the same day as this application, the entire contents of which are hereby incorporated herein by reference for all purposes).

Accordingly, by monitoring the quantity of liquid output (e.g. using one or more flow measurement sensors), the station 320 may be able to accurately determine the quantity of consumables used in creating the liquid output. For example, since the relative quantities or ratio of carbon dioxide and water can be set (e.g. based on a determined equilibrium condition), and since the carbonator 322 operates accurately, measuring the quantity of liquid output will also provide an accurate indication of the quantity of carbon dioxide gas and liquid water that was consumed.

Furthermore, this can generally be accomplished without the need to measure the quantity of gas in any particular storage tank 326 (e.g. using a scale or another technique), and without the need to monitor the flow rate of the gas and/or the liquid to the carbonator 322.

In some embodiments, one or more sensors may be provided within the carbonator 322 to monitor the liquid output and determine the quantity of gas consumed. In other embodiments, one or more sensors may be provided external to the carbonator 322 (e.g. on one or more fluid conduits used to supply carbonated liquid).

Each station 320 may be configured to collect information about the consumables used, and at one or more times communicate information about the consumables over one or more communications networks (such as the internet 302) to a data center 304 which can store and collect the data, and which may be used to perform analysis of the data.

In some embodiments, the stations 320 may be configured to communicate with the data center 304 using one or more gateways 310, which may be connected using one or more of a wired connection and a wireless connection (e.g. over a wireless access point 311 using an RF transceiver, or over a cellular network).

Once the gas and/or liquid consumption data for the various stations 320 is received at the data center 304, this information may be used to provide benefits such as improved supply chain management, better raw material control, and improved fleet and delivery scheduling.

For example, one or more users 308 may access the data using one or more workstations 306 to determine when the gas supply tanks 326 at particular stations 320 are in need of replenishment, and schedule a suitable delivery according (e.g. adjusting the quantity and types of gas supply tanks (e.g. carbon dioxide, nitrogen, or another gas) to be delivered).

In some embodiments, the data center 304 may be configured to automatically determine delivery schedules according to the data collected. The data center 304 may be configured to notify one or more users 308 (e.g. using email, instant message or another communications device) to deliver particular types and quantities of gas to particular stations 320.

In various embodiments, the liquid may be a beer, a fruit juice, a flavored juice, a coffee or coffee-flavored beverage, or a tea.

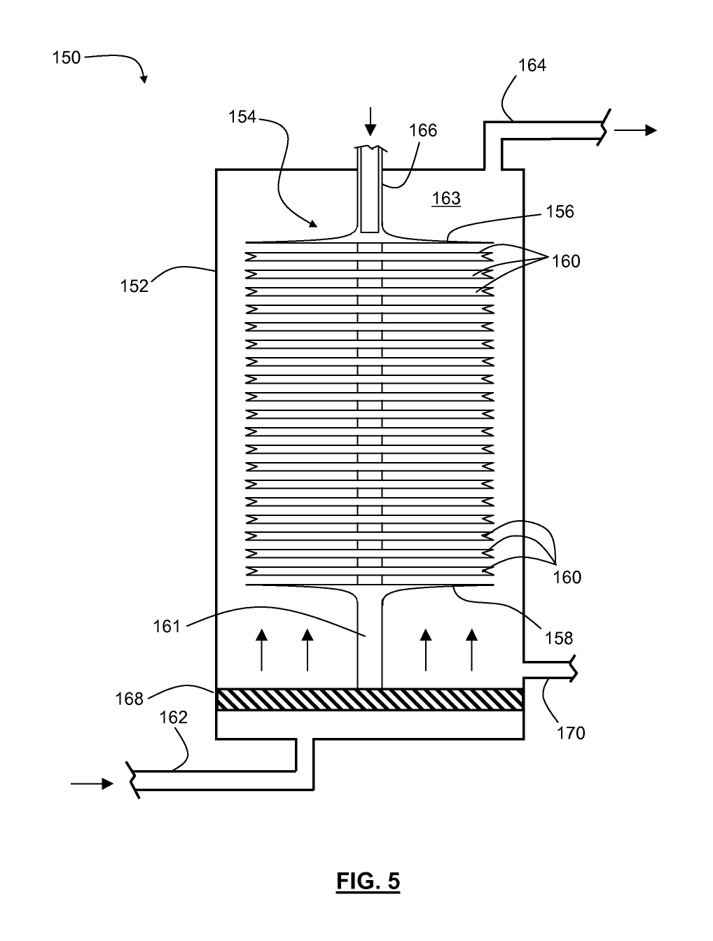

Turning now to FIG. 5, in some embodiments an apparatus 150 may be operated as a general-purpose chemical process industry amplifier according to some embodiments, and may be used for various applications such as purification of contaminated fluids, mixing of chemicals, effecting heat transfer between different fluids, and so on.

The apparatus 150 as shown generally includes a tank 152 and a rotor assembly 154 provided within the tank 152. As shown, the rotor assembly 154 has surfaces that define at least one capillary therein.

For example, the rotor assembly 154 may include one or more rotor plates that cooperate to define the capillary surfaces, including an upper rotor plate 156 near the top of the tank 152, a bottom rotor plate 158 near the bottom of the tank 152, and a plurality of intermediate rotor plates 160 between the upper and lower rotor plates 156, 158. The rotor plates 156, 158, 160 may be coupled to a common shaft or spindle 161 so that they rotate in unison as the apparatus 150 operates.

The apparatus 150 generally includes a first inlet 162 for providing a first gas into the chamber 163 of the tank 152. As shown, the inlet 162 may be located at or near the bottom of the tank 152.

The apparatus also includes a first outlet 164 for extracting fluids from the chamber 163. As shown, the first outlet 164 may be located at or near the top of the tank 152.

The apparatus 150 also includes a second inlet 166 (e.g. a feed tube) for providing liquid to the rotor assembly 154.

In some embodiments, the apparatus 150 may also include a first filter member 168. As shown, the filter member 168 may be positioned between the lower rotor plate 158 and the first inlet 162. The filter member 168 may inhibit excess liquid in the tank 152 from flowing outwardly through the first inlet 162.

In some embodiments, the tank 152 may include a fluid outlet 170 for draining excess liquid from the chamber 163 of the tank 152. As shown, the fluid outlet 170 may be provided near the filter member 168.

During use, a gas may be fed into the tank 152 through the first inlet 162. The gas may then pass upwardly through the filter member 168 into the chamber 163, where the gas can interact with the particles of liquid as they separate from the surfaces of the spinning rotor plates 156, 158, 160. The resulting mixture can then be extracted through the outlet 164.

Generally, the apparatus 150 may provide for increased rates of chemical reaction, enhanced mass transfer, or both, as compared to conventional systems (which may use for example use packed beds of materials to effect mixing between a liquid and a gas).

For example, in some embodiments the particles of liquid will react with the gas within the chamber according to some chemical reaction, optionally with or without the presence of a catalyst.

In some embodiments, at least one of the temperature and pressure within the tank 152 may be adjusted to achieve a desired chemical reaction. For example, in some embodiments the pressure in the tank 152 may be greater or lower than atmospheric pressure. In some embodiments, the temperature in the tank 152 may be raised (e.g. using heaters) or lowered (e.g. using a cooling apparatus). Raising or lowering the temperature and pressure within the tank 152 may be used to increase or reduce particular rates of chemical reaction to achieve desired results.

In one embodiment, the apparatus 150 may be used as a fluid purifier. Fluids frequently become contaminated during use and must normally be purified before they can be recycled or reused. For example, lubricants, hydraulic fluids, transformer oils, and cutting fluids often become contaminated with water, cleaning solvents, or other volatile contaminants which must be separated from the fluids before the fluids can be reused.

A variety of fluid purifiers have been previously designed based on the use of heat or vacuum or both to separate a volatile contaminant from a fluid. One problem with previous fluid purifiers is providing sufficient purification in a single pass through the purifier without harming the fluid itself. Purifiers with harsh processing conditions, such as excessive heat or excessive vacuum, may provide sufficient purification in a single pass, but they often have destructive effects on the fluids being purified. For example, the fluid can be seriously altered through the loss of low boiling point components, removal of additives, or oxidation or charring of the fluid.

On the other hand, purifiers with milder processing conditions, such as lower temperature or lower vacuum, may not harm the fluid being purified, but they often provide only partial purification in a single pass. The fluid must be pumped through the purifier many times for sufficient purification. This multi-pass approach substantially increases the amount of energy and time needed to purify the contaminated fluid.

However, using the apparatus 150, it is generally possible to provide fluid purification of large quantities of fluid and to high purity levels in a single pass without providing harsh processing conditions. In particular, a plurality of rotor plates can be stacked together to provide the desired number of capillary surfaces, thus providing for very high quantities of fluid throughput. Furthermore, this can be accomplished without elevated temperatures or pressures, which could have undesirable effects on the fluids.

For example, a contaminated liquid can be provided to the rotor apparatus 154 though the inlet 166, and the separated into particles. Since the particles tend to have very large surface area to volume ratios (as the particles are very small), contaminants within the liquid tend to be released from the particles where they can react with, and/or be absorbed by, the gas.

In some embodiments, a gas containing undesired contaminants may be purified by passing the gas through the chamber 153 and using a liquid in the rotor assembly 154 that reacts with or binds to the undesired contaminants, which will tend to remove the contaminants from the gas (and may result in the contaminants being collected as excess liquid that can be drained using the outlet 170). In this manner, the gas can be “scrubbed” or cleaned.

In some embodiments the apparatus 150 may provide for desired liquid particle sizes, including fine mists or sprays, without the need to increase the pressure within the tank 152. This is in contrast to conventional spray-type devices, which may generate sprays of liquid and gas using elevated pressures.

Generally, the apparatus 150 is viscosity independent, and can be operated with high viscosity and low viscosity liquids. Accordingly, the apparatus 150 can provide for mass transfer, and/or chemical reaction of highly viscous fluids (e.g. heavy oils, etc.), and which is normally very difficult using conventional apparatus.

Furthermore, the apparatus 150 may also be operated in conditions where the viscosity in the liquid is increasing, such as during a polymerization reaction.

In some embodiments, the apparatus 150 may operate as a heat exchanger, with hot oil or another liquid being provided and separating from the rotor plates to heat gas passing through the tank 152. In such embodiments, a filter may be provided in or before the outlet 164 so as to remove any liquid particles (e.g. oil) from the heated gas before it passes through the outlet 164.

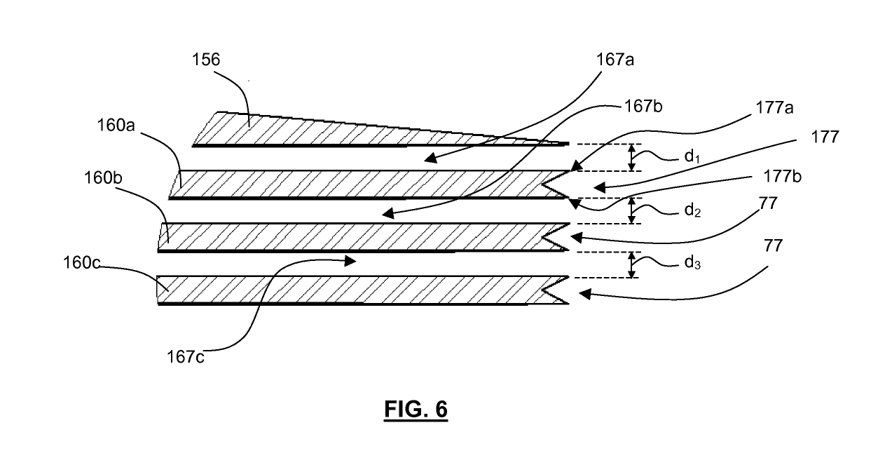

Turning now to FIG. 6, as shown the intermediate rotor plates 160 may be provided with bifurcated edges 177, each having an upper edge 177a and a lower edge 177b that allow two separate particles streams to emerge from the upper edge 177a and lower edge 177b, respectively, of each plate 69. Each edge 177a, 177b may function to release particles as generally described above. In some examples the bifurcated edges 177 may be V-shaped (as shown), U-shaped, or have any other suitable configuration.

This provision for two emitting surfaces (e.g. edges 177a, 177b) on each intermediate rotor plate 160 tends to double the potential for particle production and a stack of such plates increases particle production enormously as compared to a single flat disc or even a stack of discs that use a single surface.

In some embodiments, the bifurcated edges 177 may be sharpened edges so as to inhibit the formation of pools of liquids thereon.

In other embodiments, the edges of the rotor plates 156, 158, 160 may have various configurations to form particles of different sizes and shapes. For example, some intermediate rotor plates 160 could be provided with blunt edges, while other rotor plates 160 could have sharp edges or bifurcated edges 177. In this manner, it may be possible to form particles having different sizes and shapes simultaneously using the rotor assembly 154.

As shown, the rotor plates 156, 158, 160 define a plurality of capillaries 167, including a first capillary 167a between the upper rotor plate 156 and the first intermediate rotor plate 160a, a second capillary 167b between the first intermediate rotor plate 160a and the second intermediate rotor plate 160b, a third capillary 160c between the second intermediate rotor plate 160b and the third intermediate rotor plate 160c, and so on.

Each capillary 167a, 167b, 167c has a corresponding gap distance d₁, d₂, d₃, In some embodiments, the gap distances d₁, d₂, d₃, may each be the same or be generally similar. In other embodiments, the gap distances d₁, d₂, d₃, may vary. For example, a first gap distance d₁ may be selected so as to be greater than a second gap distance d₂, and so on.

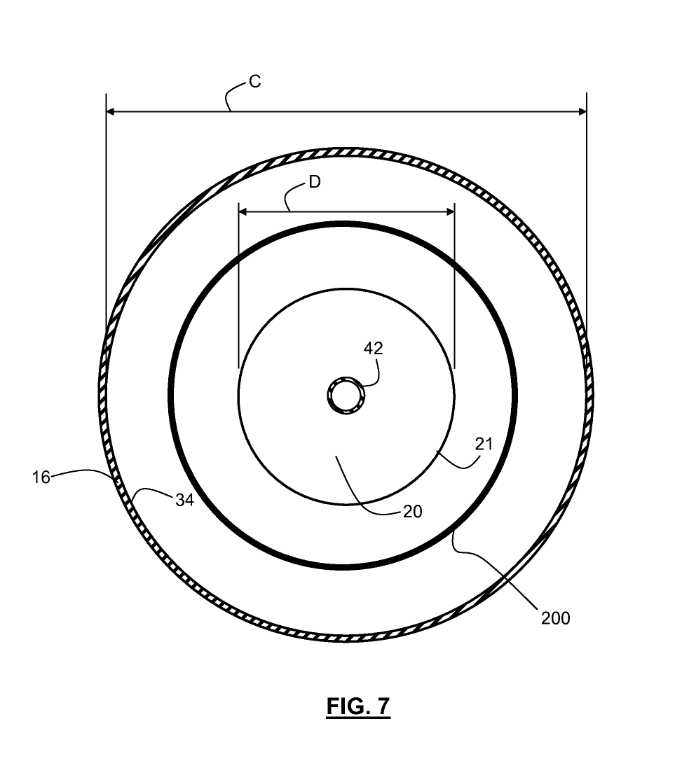

Turning now to FIGS. 7 to 9, in some embodiments the disc 20 may be surrounded by a ring member 200. The ring member 200 may further assist in the coalescence of the liquid particles.

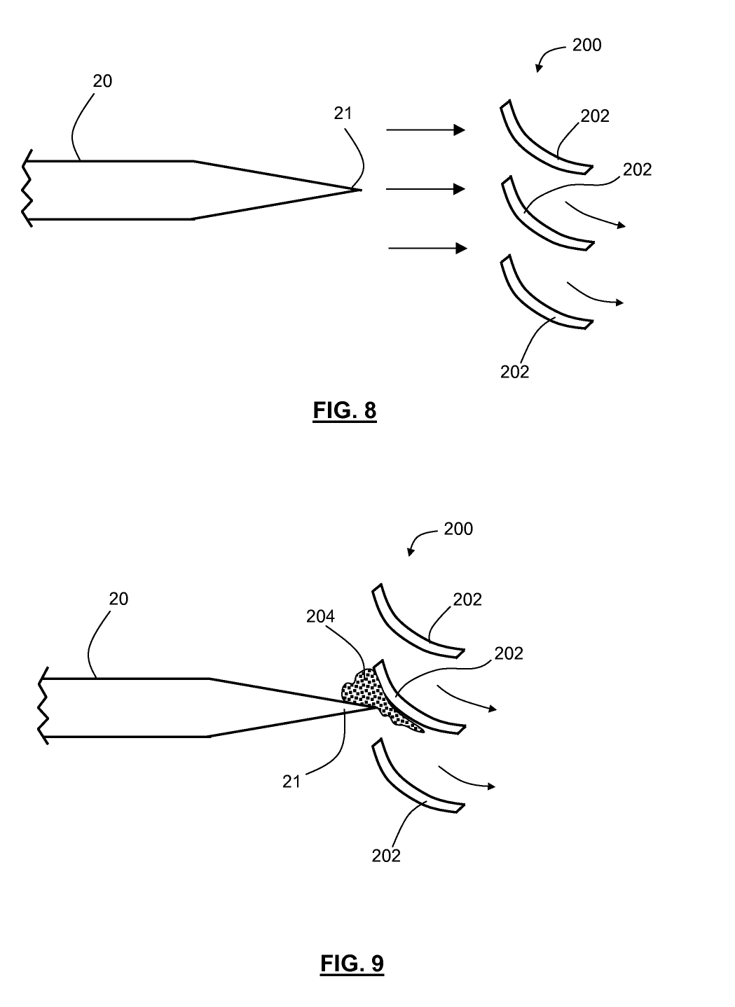

For example, as shown in FIG. 8, the ring member 200 may include a plurality of spaced apart curved portions 202 that have spaces or slots therebetween. The curved portions 202 may be positioned to engage with at least some of the liquid particles as the separate from the disc 20, coalesce, and then flow through the spaces or slots between the curved portions 202.

In some embodiments, the curved portions 202 may be made of steel or another metal.

As shown in FIG. 9, in some embodiments the curved portions 202 may be positioned sufficiently close to the edge 21 of the disc so that liquid 204 can we both the disc 20 and at least one of the curved portions 202 simultaneously.

This wetting tends to create shear within the liquid 204, and may be beneficial in helping to reducing foaming of the liquid particles, which may occur due to air entrainment and which may be undesirable in certain embodiments.

While the above description provides examples of one or more methods and/or apparatuses, it will be appreciated that other methods and/or apparatuses may be within the scope of the present description as interpreted by one of skill in the art.

1. A method for monitoring consumption of at least one consumable in a mass transfer system, comprising:
providing at least one accurate mass transfer apparatus configured to provide mass transfer of a gas into a liquid to generate a liquid output, wherein the relative amounts of liquid and gas are set; and
for each mass transfer apparatus:
a. measuring the amount of liquid output; and
b. determining, based on the amount of liquid output and the relative amounts of liquid and gas, a quantity of at least one of the gas and liquid consumed in that mass transfer apparatus.

2. The method of claim 1, further comprising, for one or more of the mass transfer apparatus, communicating the quantity of gas consumed by that mass transfer apparatus to a data center, and performing at least one data analysis on the quantity of gas consumed.

3. The method of claim 2, further comprising adjusting a delivery schedule for the gas to one or more of the mass transfer apparatus based on the quantity of gas consumed at the one or more mass transfer apparatus.

4. The method of claim 1, further comprising, for one or more of the mass transfer apparatus, communicating the quantity of liquid consumed by that mass transfer apparatus to a data center, and performing at least one data analysis on the quantity of liquid consumed.

5. The method of claim 1, wherein the relative amounts of liquid and gas are set according to an equilibrium condition in the mass transfer apparatus.

6. The method of claim 1, wherein the gas is carbon dioxide and the mass transfer apparatus is a carbonator.

7. The method of claim 1, wherein each mass transfer apparatus comprises:
a tank that defines a chamber for receiving the gas; and
at least one surface provided within the chamber, each surface having an inner region, an outer region and an edge adjacent the outer region;
wherein each surface is configured to receive the liquid at the inner region and rotate such that the liquid flows on the surface from the inner region to the outer region, and, upon reaching the edge of the surface, separates to form liquid particles that move outwardly through the gas in the chamber;
and wherein the liquid particles are sized so that the gas is absorbed by the liquid particles to produce a liquid saturated with the gas during a flight time of the liquid particles within the chamber.

8. The method of claim 1, wherein the liquid is water.

9. The method of claim 1, wherein the liquid is beer.

10. The method of claim 1, wherein the liquid is a fruit juice.

11. The method of claim 1, wherein the liquid is a flavoured juice

12. The method of claim 1, wherein the liquid is coffee.

13. The method of claim 1, wherein the liquid is a coffee flavored beverage.

14. The method of claim 1, wherein the liquid is tea.

15. The method of claim 1, wherein the liquid is a pre-mix.

16. A system for monitoring consumption of at least one consumable in a mass transfer system, comprising:
at least one consuming station, each station having:
an accurate mass transfer apparatus configured to provide mass transfer of the gas into the liquid to generate a liquid output, wherein the relative amounts of liquid and gas are set; and
a sensor configured to monitor the quantity of liquid output;
at least one processor configured to determine, based on the quantity of liquid output and the relative amounts of liquid and gas, a quantity of at least one of the liquid and the gas consumed in the mass transfer apparatus.

17. The system of claim 16, further comprising a data center configured to communicate with the at least one processor to monitor the quantity of at least one of the gas and liquid consumed by each station.

18. The system of claim 17, wherein the data center is further configured for performing at least one data analysis on at least one of the quantity of gas and liquid consumed.

19. The system of claim 17, wherein the data center is configured to adjust a delivery schedule for at least one of the gas and liquid based on the quantity of at least one of the gas and liquid consumed by each station.

20. The system of claim 16, wherein the relative amounts of liquid and gas are set according to an equilibrium condition in the mass transfer apparatus.
